(19) United States
(12) Patent Application Publication
(10) Pub. No.: US 2023/0138990 A1
(43) Pub. Date: May 4, 2023

(54) Importance Sampling via Machine Learning (ML)-Based Gradient Approximation

(71) Applicant: VMware, Inc., Palo Alto, CA (US)

(72) Inventors: Yaniv Ben-Itzhak, Herzliya (IL); Shay Vargaftik, Herzliya (IL); Boris Shustin, Tel Aviv (IL)

(21) Appl. No.: 17/518,107

(22) Filed: Nov. 3, 2021

(51) Int. Cl. G06N 3/08; G06N 3/04

(52) U.S. Cl. CPC G06N 3/084; G06N 3/0454

(57) ABSTRACT

Techniques for implementing importance sampling via machine learning (ML)-based gradient approximation are provided. In one set of embodiments, these techniques include (1) training a deep neural network (DNN) on a training dataset using stochastic gradient descent and (2) in parallel with (1), training a separate ML model (i.e., gradient approximation model) that is designed to predict gradient norms (or gradients) for the data instances in the training dataset. The techniques further include (3) applying the gradient approximation model to the training dataset on a periodic basis to generate gradient norm/gradient predictions for the data instances in the training dataset and (4) using the gradient norm/gradient predictions to update sampling probabilities for the data instances. The updated sampling probabilities can then be accessed during the ongoing training of the DNN (i.e., step (1)) to perform importance sampling of data instances and thereby accelerate the training procedure.

### BACKGROUND

Unless otherwise indicated, the subject matter described in this section is not prior art to the claims of the present application and is not admitted as being prior art by inclusion in this section.

Deep neural networks (DNNs), which are machine learning (ML) models composed of multiple layers of interconnected nodes, are widely used to solve tasks in various fields such as computer vision, natural language processing, telecommunications, bioinformatics, and so on. A DNN is typically trained via a stochastic gradient descent (SGD)-based optimization procedure that involves (1) randomly sampling a batch (sometimes referred to as a “minibatch”) of labeled data instances from a training dataset, (2) forward propagating the batch through the DNN to generate a set of predictions, (3) computing a difference (i.e., “loss”) between the predictions and the batch's labels, (4) performing backpropagation with respect to the loss to compute a gradient, (5) updating the DNN's parameters in accordance with the gradient, and (6) iterating steps (1)-(5) until the DNN converges (i.e., reaches a state where the loss falls below a desired threshold). Once trained in this manner, the DNN can be applied during an inference phase to generate predictions for unlabeled data instances.

Generally speaking, the use of larger datasets for training results in more accurate DNNs. However, as the amount of training data increases, the computational overhead and time needed to carry out the SGD training procedure also rises. To address this, importance sampling has been proposed as a technique for accelerating the training of DNNs. With importance sampling, each data instance in the training dataset is assigned a sampling probability that corresponds to the “importance” of the data instance to the training procedure, or in other words the degree to which that data instance contributes to progress of the training towards model convergence. Then, at each training iteration, data instances are sampled from the training dataset based on their respective sampling probabilities rather than at random, thereby causing more important data instances to be selected with higher likelihood than less important data instances and leading to an overall reduction in training time. It has been found that the optimal sampling probability for a given data instance is proportional to the norm (i.e., size) of the gradient computed for that data instance via SGD.

One challenge with implementing importance sampling is that it is impractical to compute exact gradient norms (and thus, optimal sampling probabilities) for an entire training dataset at each training iteration, because this requires time-consuming forward and backpropagation passes through the DNN for every data instance in the training dataset. Current importance sampling approaches attempt to work around this problem using various methods but suffer from their own set of limitations (e.g., reliance on outdated/stale gradient norm information, inability to support batches, etc.) that adversely affect training performance.

### BRIEF DESCRIPTION OF THE DRAWINGS

FIG. 1 depicts an example environment in which embodiments of the present disclosure may be implemented.

FIG. 2 depicts an example DNN.

FIG. 3 depicts a flowchart for training a DNN via SGD according to certain embodiments.

FIG. 4 depicts an example training dataset with sampling probabilities.

FIGS. 5A and 5B depict the design of an importance sampling solution that makes use of a gradient approximation model according to certain embodiments.

FIG. 6 depicts a flowchart for training a gradient approximation model according to certain embodiments.

FIG. 7 depicts a flowchart for applying a gradient approximation model to determine/update sampling probabilities according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof

### 1. Overview

Embodiments of the present disclosure are directed to techniques for implementing importance sampling via ML-based gradient approximation. In one set of embodiments, these techniques include (1) training a DNN on a training dataset using SGD and (2) in parallel with (1), training a separate ML model (referred to herein as a “gradient approximation model” or “GAM”) that is designed to predict gradient norms (or gradients) for the data instances in the training dataset. The training of the gradient approximation model can be based on exact gradient norms/gradients computed for a subset of data instances via forward and backpropagation passes through the DNN.

The techniques further include (3) applying the gradient approximation model to the training dataset on a periodic basis to generate gradient norm/gradient predictions for the data instances in the training dataset and (4) using the gradient norm/gradient predictions to update sampling probabilities for the data instances. Steps (3) and (4) can be performed concurrently with (1) and (2). The updated sampling probabilities can then be accessed during the ongoing training of the DNN (i.e., step (1)) to perform importance sampling of data instances and thereby accelerate the training procedure.

### 2. Example Environment and High-Level Solution Design

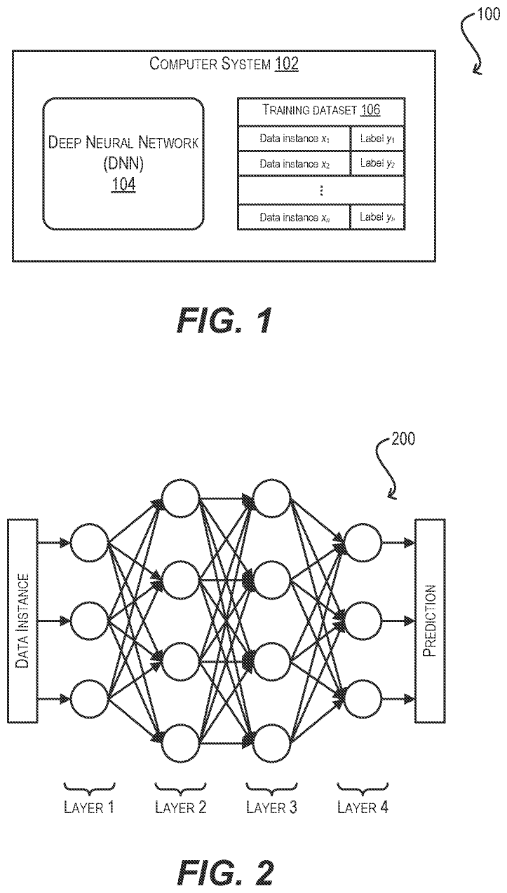

FIG. 1 depicts an example environment 100 in which embodiments of the present disclosure may be implemented. As shown, environment 100 includes a computer system 102 that is configured to train a DNN 104 on a training data set 106. Training dataset 106 comprises n data instances {x₁, . . . , xₙ}, each associated with a label yᵢ indicating the correct prediction/output for that data instance. DNN 104 is type of ML model that comprises a collection of nodes, also known as neurons, that are organized into layers and interconnected via directed edges. For instance, FIG. 2 depicts an example representation 200 of DNN 104 that includes a total of fourteen nodes and four layers 1-4. The nodes and edges are associated with parameters (e.g., weights and biases, not shown) that control how a data instance, when provided as input via the first layer, is forward propagated through the DNN to generate a prediction, which is output by the last layer. These parameters are the aspects of the DNN that are adjusted via training in order to optimize the DNN's accuracy (i.e., ability to generate correct predictions).

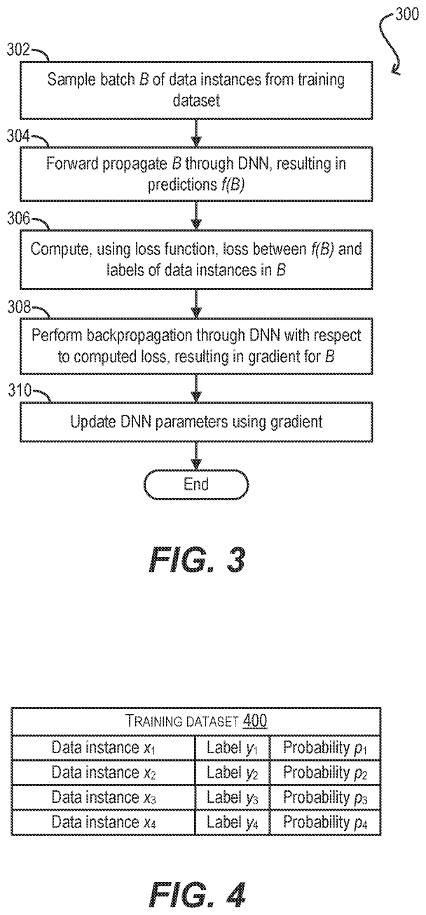

FIG. 3 depicts a flowchart 300 that may be executed by computer system 102 for training DNN 104 on training dataset 106 using a conventional SGD-based procedure. SGD-based training proceeds over a series of iterations and flowchart 300 depicts the steps performed in a single iteration. Starting with steps 302 and 304, computer system 102 randomly samples a batch B of data instances from training dataset 106 and forward propagates the batch through DNN 104, resulting in a set of predictions f (B). Computer system 102 further computes a loss between f (B) and the labels of the data instances in B using a loss function (step 306) and performs backpropagation through DNN 104 with respect to the computed loss, resulting in a gradient vector (or simply “gradient”) for B (step 308). Finally, computer system 102 updates the parameters of DNN 104 using the gradient (step 310) and the flowchart ends. Steps 302-310 are thereafter repeated for further iterations until DNN 104 converges (i.e., achieves a desired level of accuracy) or some other termination criterion, such as a maximum number of training iterations, is reached.

As noted in the Background section, importance sampling is an enhancement to conventional SGD-based training that involves assigning a sampling probability to each data instance in the training dataset. This sampling probability indicates the importance, or degree of contribution, of the data instance to the training procedure. For instance, FIG. 4 depicts an example training dataset 400 that includes four data instances {x₁, x₂, x₃, x₄} with corresponding labels {y₁, y₂, y₃, y₄} and assigned sampling probabilities {p₁, p₂, p₃, p₄}. With these sampling probabilities in place, data instances can be sampled from the training dataset at each training iteration based on their respective probabilities, rather than randomly as described at step 302 of flowchart 300. This advantageously increases the likelihood that more important data instance instances will be selected over less important data instances for training, leading to faster model convergence.

However, implementing importance sampling in practice is difficult because determining the optimal sampling probability for each data instance—which is proportional to the gradient norm computed for that data instance via SGD—is a time-consuming task. Current importance sampling approaches employ a number of workarounds that mitigate the cost of updating sampling probabilities, but these approaches are susceptible to poor probability accuracy in some scenarios and/or introduce other performance problems.

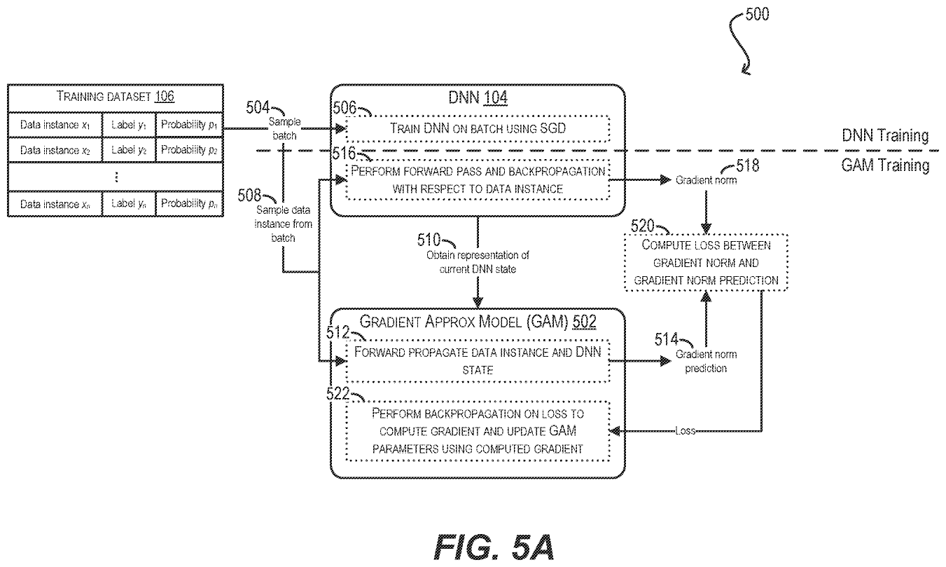

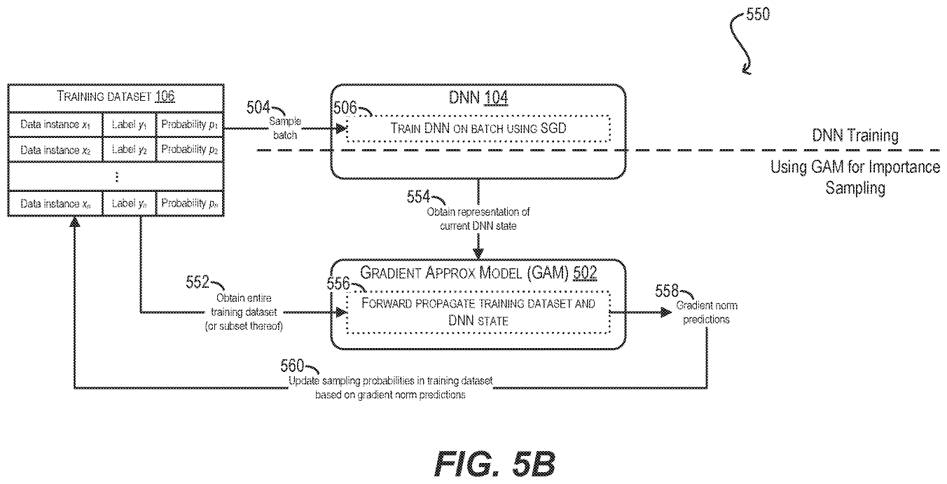

To address the foregoing, FIGS. 5A and 5B depict high-level workflows 500 and 550 of a novel importance sampling solution that can be implemented by computer system 102 as part of its training of DNN 104 according to certain embodiments. This novel solution leverages a second ML model, shown in FIGS. 5A and 5B as gradient approximation model (GAM) 502, that is designed to predict the gradient norms of data instances in training dataset 106 with respect to DNN 104. By employing GAM 502, computer system 102 can quickly update the sampling probabilities for those data instances on a rolling basis with close-to-optimal probability values, resulting in more efficient and effective importance sampling when compared to existing approaches.

Workflow 500 of FIG. 5A pertains to the training of GAM 502 (in conjunction with the training of DNN 104) and workflow 550 of FIG. 5B pertains to the use of GAM 502 in updating sampling probabilities for the data instances in training dataset 106. These workflows assume that each data instance xᵢ in training dataset 106 is initialized with a default sampling probability pᵢ at the start of the training of DNN 104; for example, each xᵢ may be initialized with the same value for pᵢ according to a uniform probability distribution.

Starting with workflow 500, at steps 504 and 506, computer system 102 can sample a batch of data instances from training dataset 106 based on their current sampling probabilities and use this batch to train DNN 104 via the standard SGD-based training procedure described at steps 304-310 of FIG. 3 (e.g., forward propagate the batch through DNN 104 to generate a set of predictions, compute a loss between the predictions and the batch's labels, perform backpropagation with respect to the loss to compute a gradient, and update the parameters of DNN 104 based on the gradient).

Concurrently with steps 504 and 506, computer system 102 can sample a data instance from the batch used to train DNN 104 (step 508) and obtain a representation of the current state of DNN 104 (step 510). In one set of embodiments, this representation can include exact and up-to-date values for all of the DNN's parameters. In other embodiments, this representation can include an approximation or subset of the DNN's current parameter values, such as a sketch, random sub sample of parameters, etc.

At step 512, computer system 102 can forward propagate the data instance and the DNN state representation through GAM 502, resulting in a gradient norm prediction 514 for those inputs. In addition, at step 516, computer system 102 can perform a forward and backpropagation pass through DNN 104 with respect to the data instance, thereby computing a gradient norm 518 for the data instance.

Upon obtaining gradient norm prediction 514 and gradient norm 518, computer system 102 can compute a loss between these two values (step 520). Finally, computer system 102 can perform backpropagation through GAM 502 with respect to the loss determined at step 520 to compute a gradient and can update the parameters of GAM 502 based on the gradient (step 522). Computer system 102 can thereafter iterate steps 508-522 in order to further train GAM 502 until the training of DNN 104 is complete or some other termination criterion is fulfilled, such as reaching an accuracy threshold or number of training iterations threshold for GAM 502.

Turning now to workflow 550, at steps 552 and 554, computer system 102 can obtain the entirety of training dataset 106 (or specific data instances therein) and a representation of the current state of DNN 104 and provide these as inputs to GAM 502. As mentioned previously, this state representation can include current and exact values for all of the parameters of DNN 104 or some approximation/subset of those parameter values.

At step 556, computer system 102 can forward propagate training dataset 106 and the DNN state representation through GAM 502, resulting in a set of gradient norm predictions 558. Computer system 102 can then update the sampling probabilities for the data instances in training dataset 106 (i.e., {p₁, . . . , pₙ} based on their respective gradient norm predictions (step 560) and use the updated sampling probabilities as part of its ongoing training of DNN 104 (steps 504 and 506). Finally, although not explicitly shown, computer system 102 can repeat steps 552-560 on a periodic basis in order to ensure that the sampling probabilities in training dataset 106 are kept relatively up to date with the current state of DNN 104.

It should be noted that the training of GAM 502 via workflow 500 and the application of GAM 502 for importance sampling via workflow 550 can be performed mostly or entirely in parallel. In certain embodiments, GAM 502 can be trained for a number of iterations prior to being used to update sampling probabilities in training dataset 106. For instance, once the accuracy of GAM 502 reaches a desired level (or in other words, the loss computed at step 520 of workflow 500 falls below a threshold), workflow 550 can be initiated.

The remaining sections of this disclosure provide additional implementation details regarding the high-level workflows shown in FIGS. 5A and 5B. It should be appreciated that these figures are illustrative and not intended to limit embodiments of the present disclosure. For example, although the description of FIGS. 5A and 5B above assumes that DNN 104, training dataset 106, and GAM 502 reside on a single computer system 102 for ease of illustration and explanation, other physical deployments of these components are possible (e.g., they may all reside on different computer systems, DNN 104 and training dataset 106 may reside on a first computer system while GAM 502 resides on a second computer system, etc.). Section (5) below describes various possible deployments and techniques for reducing network bandwidth usage/overhead in these deployments when executing workflows 500 and 550.

Further, although FIG. 5A indicates that each training iteration of GAM 502 is performed using a single data instance, in alternative embodiments multiple data instances may be used. Such multiple data instances may be sampled from a single batch or several different batches used to train DNN 104. In these embodiments, the multiple data instances can be forward propagated through GAM 502 and DNN 104 as a group/batch for computational efficiency, while the backpropagation performed at steps 522 and 516 may be executed with respect to each individual data instance (in order to obtain its individual gradient norm or gradient norm prediction).

Yet further, in certain embodiments GAM 502 may be configured to predict gradients, rather than gradient norms, for data instances in training dataset 106. The gradient predictions output by GAM 502 can then be used to compute gradient norm predictions 514 and 558 shown in workflows 500 and 550 (by applying a norm function to the gradient predictions). While this approach can increase the size and complexity of GAM 502, it can also be leveraged to increase the batch size used to train DNN 104 (and thus further accelerate its training) without significantly adding to the computational overhead of the training procedure.

For example, assume that the batch size for training DNN 104 is originally set at 50 data instances and increased to 100 data instances. In this scenario, 50 of the data instances may be forward and back propagated through DNN 104 in order to compute their exact gradients via SGD, while the remaining 50 data instances may be forward propagated through GAM 502 in order to generate predicted/approximated gradients for those data instances. The exact and predicted/approximated gradients can then be combined and applied to update the parameters of DNN 104. Because the forward pass through GAM 502 is less resource intensive than performing both forward and backpropagation passes through DNN 104, this approach will not be significantly more expensive than solely computing exact gradients for the original batch size of 50, and yet will likely achieve faster convergence of DNN 104 due to the consideration of 50 additional data instances per batch.

### 3. Training the Gradient Approximation Model

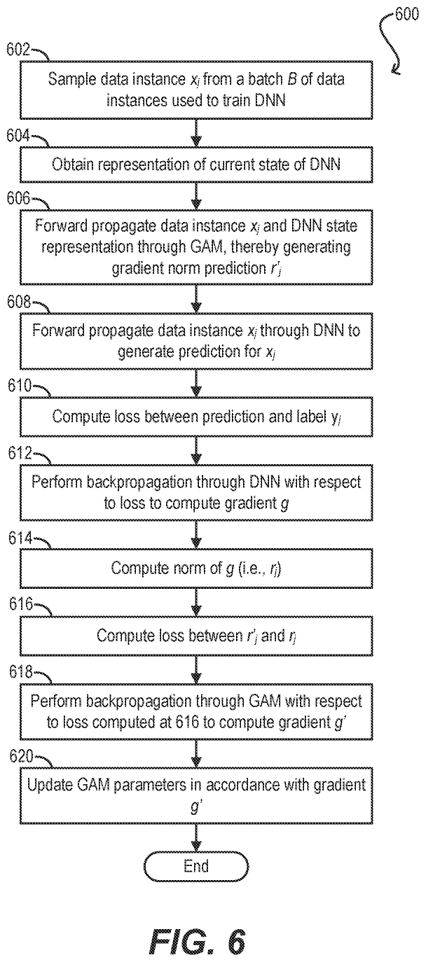

FIG. 6 depicts a flowchart 600 that provides additional details regarding the processing that may be performed by computer system 102 for training GAM 502 (per workflow 500 of FIG. 5A) according to certain embodiments. The steps shown in this flowchart pertain to actions executed in a single training iteration of GAM 502.

At step 602, computer system 102 can sample a data instance xⱼ from a batch B of data instances used to train DNN 104. In addition, at step 604, computer system 102 can obtain a representation of the current state of DNN 104. As noted previously, this representation can include the entire/exact state of DNN 104 (i.e., exact versions of all of its current parameter values) or an approximation or subset thereof. For example, this approximation or subset may be obtained via sketching, random subsampling, sparsification, or quantization of the original parameter values.

At step 606, computer system 102 can forward propagate data instance xⱼ and the DNN state representation through GAM 502, thereby generating a gradient norm prediction r′ⱼ for xⱼ. Computer system 102 can further forward propagate data instance xⱼ through DNN 104 to generate a prediction for xⱼ (step 608), compute a loss between the prediction and xⱼ's label yⱼ (step 610), perform backpropagation through DNN 104 with respect to the loss to compute a gradient g (step 612), and compute the norm of the gradient (i.e., rⱼ) (step 614).

At steps 616 and 618, computer system 102 can compute a loss between gradient norm prediction r′ⱼ and gradient norm rⱼ and can perform backpropagation through GAM 502 with respect to this loss to compute a gradient g′. Finally, computer system 102 can update the parameters of GAM 502 in accordance with gradient g′ (step 620) and flowchart 600 can end.

### 4. Applying the Gradient Approximation Model for Importance Sampling

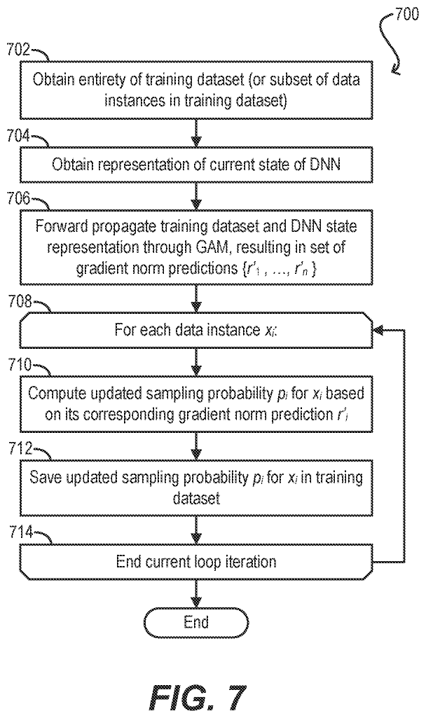

FIG. 7 depicts a flowchart 700 that provides additional details regarding the processing that may be performed by computer system 102 for applying GAM 502 to update sampling probabilities for data instances in training dataset 106 (per workflow 550 of FIG. 5B) according to certain embodiments. Flowchart 700 can be repeated periodically, such as at predefined intervals (e.g., every M minutes) or at dynamic intervals in response to the state of DNN 104. For example, in a particular embodiment the frequency of iterating flowchart 700 may be based on the computed loss for DNN 104, with higher loss values resulting in more frequent iterations and lower loss values resulting in less frequent iterations.

Starting with steps 702 and 704, computer system 102 can obtain the entirety of training dataset 106 (or a subset of data instances in the training dataset) and a representation of the current state of DNN 104. Computer system 102 can then forward propagate training dataset 106 and the DNN state representation through GAM 502, resulting in a set of gradient norm predictions {r′₁, . . . r′ₙ} corresponding to data instances {x₁, . . . , xₙ} (step 706).

At step 708, computer system 102 can enter a loop for each data instance xᵢ in training dataset 106. Within this loop, computer system 102 can compute an updated sampling probability pᵢ for data instance xᵢ based on its corresponding gradient norm prediction r′ᵢ (step 710). For example, in one set of embodiments pᵢ can be computed as follows:

$${p}_{i} = \frac{{r}_{i}^{′}}{{\sum }_{j = 1}^{n} {r}_{j}^{′}} \qquad Listing 1$$

Computer system 102 can then store updated sampling probability pᵢ for xᵢ in training dataset 106 (thereby overwriting the previous value for pᵢ) (step 712) and reach the end of the current loop iteration (step 714). Once all of the data instances in training dataset 106 have been processed via this loop, flowchart 700 can end.

### 5. Alternative Physical Deployments

As mentioned in section (2), there are several ways in which DNN 104, training dataset 106, and GAM 502 may be deployed across different computer systems. For example, in a first scenario, a first computer system C1 may hold DNN 104 and a second computer system C2 may hold training dataset 106 and GAM 502. In a second scenario, computer system C1 may hold DNN 104 and training dataset 106 and computer system C2 may hold GAM 502. And in a third scenario, computer system C1 may hold training dataset 106, computer system C2 may hold GAM 502, and a third computer system C3 may hold DNN 104. In these various scenarios, the processing steps performed by computer system 102 on DNN 104 and GAM 502 can instead be performed by the computer systems holding these respective models.

Regarding the first scenario above, in some embodiments the computer system holding DNN 104 (i.e., C1) can send DNN parameter updates to the computer system holding GAM 502 (i.e., C2), rather than the entirety of the DNN's state (which is needed as an input to GAM 502 in both workflows 500 and 550). Computer system C2 can then reconstruct the full state of DNN 104 using the parameter updates and a local copy of the prior state of DNN 104 and provide the reconstructed state as input to GAM 502. This advantageously reduces the amount of data that needs to be transmitted between these computer systems.

Regarding the second and third scenarios above, in some embodiments the computer system holding GAM 502 (i.e., C2) can send a copy of the current state of GAM 502 to the computer system holding training dataset 106 (i.e., C1) at the start of workflow 550, rather than having C1 send training dataset 106 to C2. Computer system C1 can then perform the steps of workflow 550 (e.g., determination of gradient norm predictions and updating of sampling probabilities) on its local copy of GAM 502 and training dataset 106. This will generally be more efficient in terms of network bandwidth than sending training dataset 106 from C1 to C2 in order to carry out workflow 550 at C2, because in many real-world scenarios training dataset 106 will be very large in size.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
training, by a computer system, a first machine learning (ML) model by:
sampling a data instance from a batch of data instances used to train a second ML model, the batch having been sampled from a training dataset comprising a plurality of data instances;
obtaining a representation of a current state of the second ML model;
forward propagating the data instance and the representation through the first ML model, thereby generating a gradient norm prediction;
performing a forward pass and backpropagation through the second ML model with respect to the data instance, thereby computing a gradient norm;
computing a loss based on the gradient norm prediction and the gradient norm;
performing backpropagation through the first ML model with respect to the loss, thereby computing a gradient; and
updating one or more parameters of the first ML model in accordance with the gradient.

2. The method of claim 1 wherein the training of the first ML model is performed concurrently with training of the second ML model.

3. The method of claim 1 wherein the second ML model comprises a plurality of parameters and wherein the representation includes approximations or a subset of the plurality of parameters.

4. The method of claim 1 further comprising:
applying the first ML model to enable important sampling for the second ML model by:
forward propagating the training dataset and the representation through the first ML model, thereby generating a set of gradient norm predictions corresponding to the plurality of data instances; and
for each data instance in the plurality of data instances:
computing an updated sampling probability for said each data instance based on said each data instance's corresponding gradient norm prediction; and
storing the updated sampling probability in the training dataset.

5. The method of claim 4 wherein the applying of the first ML model and the training of the first ML model are performed concurrently.

6. The method of claim 4 wherein the first ML model is stored on the computer system and wherein the training dataset is stored on another computer system.

7. The method of claim 6 wherein a copy of the first ML model is transmitted from the computer system to said another computer system and wherein the applying of the first ML model is performed by said another computer system using the copy.

8. The method of claim 1 wherein the forward propagating of the data instance and the representation through the first ML model results in a gradient prediction that is used to generate the gradient norm prediction, and
wherein training of the second ML model includes:
forward propagating a subset of the batch of data instances and the representation through the first ML model, resulting in a set of gradient predictions; and
using at least the set of gradient predictions to update parameters of the second ML model.

9. A non-transitory computer readable storage medium having stored thereon program code executable by a computer system, the program code causing the computer system to execute a method comprising:
training a first machine (ML) model by:
sampling a data instance from a batch of data instances used to train a second ML model, the batch having been sampled from a training dataset comprising a plurality of data instances;
obtaining a representation of a current state of the second ML model;
forward propagating the data instance and the representation through the first ML model, thereby generating a gradient norm prediction;
performing a forward pass and backpropagation through the second ML model with respect to the data instance, thereby computing a gradient norm;
computing a loss based on the gradient norm prediction and the gradient norm;
performing backpropagation through the first ML model with respect to the loss, thereby computing a gradient; and
updating one or more parameters of the first ML model in accordance with the gradient.

10. The non-transitory computer readable storage medium of claim 9 wherein the training of the first ML model is performed concurrently with training of the second ML model.

11. The non-transitory computer readable storage medium of claim 9 wherein the second ML model comprises a plurality of parameters and wherein the representation includes approximations or a subset of the plurality of parameters.

12. The non-transitory computer readable storage medium of claim 9 wherein the method further comprises:
applying the first ML model to enable important sampling for the second ML model by:
forward propagating the training dataset and the representation through the first ML model, thereby generating a set of gradient norm predictions corresponding to the plurality of data instances; and
for each data instance in the plurality of data instances:
computing an updated sampling probability for said each data instance based on said each data instance's corresponding gradient norm prediction; and
storing the updated sampling probability in the training dataset.

13. The non-transitory computer readable storage medium of claim 12 wherein the applying of the first ML model and the training of the first ML model are performed concurrently.

14. The non-transitory computer readable storage medium of claim 12 wherein the first ML model is stored on the computer system and wherein the training dataset is stored on another computer system.

15. The non-transitory computer readable storage medium of claim 14 wherein a copy of the first ML model is transmitted from the computer system to said another computer system and wherein the applying of the first ML model is performed by said another computer system using the copy.

16. The non-transitory computer readable storage medium of claim 9 wherein the forward propagating of the data instance and the representation through the first ML model results in a gradient prediction that is used to generate the gradient norm prediction, and
wherein training of the second ML model includes:
forward propagating a subset of the batch of data instances and the representation through the first ML model, resulting in a set of gradient predictions; and
using at least the set of gradient predictions to update parameters of the second ML model.

17. A computer system comprising:
a processor; and
a non-transitory computer readable medium having stored thereon program code that, when executed by the processor, causes the processor to:
train a first machine learning (ML) model by:
sampling a data instance from a batch of data instances used to train a second ML model, the batch having been sampled from a training dataset comprising a plurality of data instances;
obtaining a representation of a current state of the second ML model;
forward propagating the data instance and the representation through the first ML model, thereby generating a gradient norm prediction;
performing a forward pass and backpropagation through the second ML model with respect to the data instance, thereby computing a gradient norm;
computing a loss based on the gradient norm prediction and the gradient norm;
performing backpropagation through the first ML model with respect to the loss, thereby computing a gradient; and
updating one or more parameters of the first ML model in accordance with the gradient.

18. The computer system of claim 17 wherein the training of the first ML model is performed concurrently with training of the second ML model.

19. The computer system of claim 17 wherein the second ML model comprises a plurality of parameters and wherein the representation includes approximations or a subset of the plurality of parameters.

20. The computer system of claim 17 wherein the program code further causes the processor to:
apply the first ML model to enable important sampling for the second ML model by:
forward propagating the training dataset and the representation through the first ML model, thereby generating a set of gradient norm predictions corresponding to the plurality of data instances; and
for each data instance in the plurality of data instances:
computing an updated sampling probability for said each data instance based on said each data instance's corresponding gradient norm prediction; and
storing the updated sampling probability in the training dataset.

21. The computer system of claim 20 wherein the applying of the first ML model and the training of the first ML model are performed concurrently.

22. The computer system of claim 20 wherein the first ML model is stored on the computer system and wherein the training dataset is stored on another computer system.

23. The computer system of claim 22 wherein a copy of the first ML model is transmitted from the computer system to said another computer system and wherein the applying of the first ML model is performed by said another computer system using the copy.

24. The computer system of claim 17 wherein the forward propagating of the data instance and the representation through the first ML model results in a gradient prediction that is used to generate the gradient norm prediction, and
wherein training of the second ML model includes:
forward propagating a subset of the batch of data instances and the representation through the first ML model, resulting in a set of gradient predictions; and
using at least the set of gradient predictions to update parameters of the second ML model.
